(19) United States
(12) Patent Application Publication
(10) Pub. No.: US 2018/0244087 A1
(43) Pub. Date: Aug. 30, 2018

(54) SEGMENTED ENCLOSURE

(71) Applicant: Datamax-O'Neil Corporation, Orlando, FL (US)

(72) Inventors: Thomas Celinder, Singapore (SG); Michael James Wells, Lake Stevens, WA (US)

(21) Appl. No.: 15/909,249

(22) Filed: Mar. 1, 2018

Related U.S. Application Data
(63) Continuation of application No. 15/443,399, filed on Feb. 27, 2017, now Pat. No. 9,908,351.

(51) Int. Cl. B41J 29/02; B41J 3/407

(52) U.S. Cl. CPC B41J 29/02; B41J 3/4075

(57) ABSTRACT

Printers and other machines providing tangible outputs are provided. In one implementation, a printer comprises a housing having a fixed structure and a movable cover configured to be movable with respect to the fixed structure. The printer also includes a printing mechanism that is disposed inside the housing and is configured to print an image on a medium. The movable cover is movably attached to the fixed structure via a first pivoting mechanism that defines a first pivoting axis. The movable cover is configured to be pivoted about the first pivoting axis of the first pivoting mechanism. Also, the movable cover comprises a plurality of linked slats, each pair of adjacent linked slats being linked together by a second pivoting mechanism. Each second pivoting mechanism includes characteristics enabling a user to detach the adjacent linked slats from each other.

### CROSS-REFERENCE TO RELATED APPLICATION

The present application claims the benefit of U.S. patent application Ser. No. 15/443,399 for a Segmented Enclosure filed Feb. 27, 2017, now U.S. Pat. No. 9,908,351. Each of the foregoing patent application and patent is hereby incorporated by reference in its entirety.

### FIELD OF THE INVENTION

The present invention relates to enclosures and more particularly relates to segmented doors for allowing access to the interior of the enclosures.

### BACKGROUND

Printers are used in a variety of professional settings for printing text and images on various types of media, such as paper, cardstock, labels, etc. Generally, printers are often installed in areas where they will take up as little real estate as possible.

Although space may be limited, a certain amount of buffer space will be needed around the printers to allow a user to access the interior of the printers when necessary. For example, the user may need to open the enclosure of the printer to reload paper or other media on which the images are printed. Also, the user may need to open the printer to replace a ribbon, toner cartridge, drum, or other printing elements or to perform other normal restocking and maintenance operations. Therefore, this buffer space is needed around the printer for allowing easy access to the interior of the printer and also to accommodate the path of one or more swinging doors or removable trays of the printer.

Since the printer's enclosure doors may be opened on a regular basis and/or the doors may be heavy or difficult to open, the user may decide to remove the doors, which might help to reduce the space needed for the printer and may provide a more convenient way to access the interior of the printer. Also, the user may remove the doors to avoid the risk of an injury due to a door accidentally closing while the user is working inside the printer.

A problem with removing printer doors, however, is that the internal printing mechanisms, such as printer heads, when exposed to the environment, may wear down faster and/or may accumulate dust and dirt. As a result, exposure to the environment may have a negative impact on the print quality or even the life span of the printer.

Therefore, a need exists for a printer, or other similar machine having one or more doors for exposing its interior, to be configured such that the doors can be easily moved out of the way when needed. Also, a need exists for the printer doors to have a low profile and, thus, not require a large buffer space around the printer for swinging the doors opened or closed.

### SUMMARY

Accordingly, in one aspect, the present invention embraces enclosures or housings of printers or other machines, wherein the doors of the enclosures or housings enable access to the interior thereof. The doors are configured, according to the embodiments disclosed herein, to be easily moved out of the way when a user needs to access the interior of the housing. Also, the printer doors are configured such that during the process of opening or closing the doors, the doors do not require a large amount of space around the printer as would normally be needed for larger, bulkier doors.

In an exemplary embodiment, a printer is provided, which comprises a housing having a fixed structure and a movable cover. The movable cover is configured to be movable with respect to the fixed structure. The printer also includes a printing mechanism disposed inside the housing, where the printing mechanism is configured to print an image on a medium. The movable cover is movably attached to the fixed structure via a first pivoting mechanism that defines a first pivoting axis. The movable cover is configured to be pivoted about the first pivoting axis of the first pivoting mechanism. The movable cover comprises a plurality of linked slats, each pair of adjacent linked slats being linked together by a second pivoting mechanism. Each of the second pivoting mechanisms includes characteristics enabling a user to detach the adjacent linked slats from each other.

In another exemplary embodiment, a housing of a machine for providing a tangible output is provided. The machine housing includes a fixed structure and a first pivoting mechanism attached to the fixed structure, the first pivoting mechanism defining a first pivoting axis. The housing also includes a cover attached to the first pivoting mechanism. The cover is configured to be pivoted with respect to the fixed structure about the first pivoting axis. When the cover is in an open position, a user has access to the interior of the housing. The cover comprises a plurality of linked slats, each pair of adjacent linked slats being linked together by a second pivoting mechanism. Each second pivoting mechanism includes characteristics enabling the user to detach the adjacent linked slats from each other.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 schematically depicts a perspective view of a printer according to an embodiment of the present invention.

FIG. 2 schematically depicts a front view of the printer of FIG. 1 with a cover in a closed position, according to an embodiment of the present invention.

FIG. 3 schematically depicts a front view of the printer of FIG. 1 with the cover in a first opened arrangement, according to an embodiment of the present invention.

FIG. 4 schematically depicts a front view of the printer of FIG. 1 with the cover in a second opened arrangement, according to an embodiment of the present invention.

FIG. 5 schematically depicts a front view of the printer of FIG. 1 with some of the slats detached, according to an embodiment of the present invention.

### DETAILED DESCRIPTION

The present invention is directed to devices such as printers or other machines that have a housing, body, or enclosure that protects the interior components of the device. In particular, the housings or enclosures described herein may include one or more doors, drawers, trays, lids, etc., which can easily be opened by the user to provide access to the interior components. For example, regarding implementations of a printer, the user may occasionally need to open the doors of the printer to load paper or other media on which text and images can be printed. Also, the user may need to open the printer to remove jammed supplies, to replace a ribbon or toner cartridge, to replace a drum, or to perform other regular tasks associated with the normal use of the printer.

According to the embodiments disclosed herein, the present invention includes segmented enclosures for allowing access to the interior of the device. The segmented enclosures, as described herein, include movable doors have linked segments or slats. The segments or slats are linked together to allow the adjacent pieces to pivot with respect to each other. Therefore, the cover or doors of the enclosure can be easily moved out of the way to enable the user to access the internal components of the device.

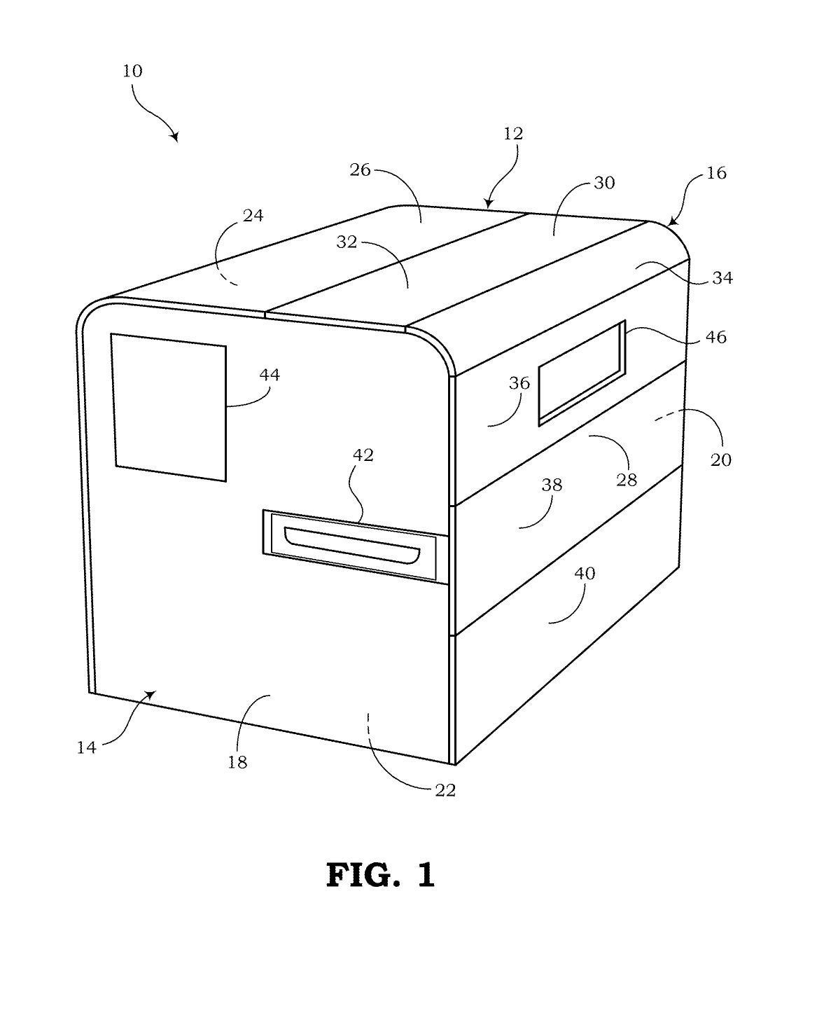

FIG. 1 is a perspective view illustrating an embodiment of a printer 10. Although the device depicted in FIG. 1 is shown as a printer or label printer, it should be noted that the device may be any type of machine capable of executing certain functionality to provide a physical output. Particularly, the machine receives or stores one or more products (e.g., paper, labels, ink, toner, etc.), performs one or more actions on the one or more products, and then produces a physical output. The physical output may perhaps be a byproduct or a modification of the one or more products. For example, in embodiments where the machine is a printer, the printer stores a medium (e.g., paper, label, etc.) and ink/toner. The machine prints an image on the medium, which is then output from the printer. According to other embodiments, the machine may alternatively be a label maker, food/beverage machine, point-of-sale (POS) device, etc. It should be recognized that the printer 10 or other devices or machines for outputting a physical product may require a user to occasionally open the housing to access the interior.

The printer 10 includes a housing 12, which includes a fixed structure 14 and a movable cover 16. The movable cover 16 is configured to be moved with respect to the fixed structure 14 to enable access to the interior of the housing 12. The fixed structure 14 in this embodiment includes at least a front portion 18, a back portion 20, a bottom portion 22, a left-side portion 24, and a first top portion 26 of the housing 12. The back portion 20, bottom portion 22, and left-side portion 24 are hidden from view in FIG. 1.

The movable cover 16 in this embodiment includes a right-side portion 28 and a second top portion 30 of the housing 12. Therefore, the top of the housing 12 consists of both the first top portion 26 of the fixed structure 14 and the second top portion 30 of the movable cover 16. The movable cover 16 is shown in FIG. 1 in its closed position. When moved away from the right-side portion 28 and/or second top portion 30 of the housing 12, the interior of the housing can be accessed. For instance, the interior of the printer 10 may include a printing mechanism from applying ink or toner to a medium.

In the embodiment of FIG. 1, the movable cover 16 is shown with a plurality of parallel slats 32, 36, 38, 40, which are linked together to allow pivoting of adjacent slats with respect to each other. In the closed position, at least a first slat 32 makes up the second top portion 30 of the housing 12. In some embodiments, the second top portion 30 may comprise more than one slat. When the movable cover 16 is in the closed position, as illustrated in FIG. 1, at least one slat makes up the right-side portion 28 of the housing 12. In the embodiment shown in FIG. 1, three slats 36, 38, 40 cumulatively form the right-side portion 28. According to other embodiments, the right-side portion 28 may include any number of slats.

The movable cover 16 also includes a curved piece 34 or slat, which may include a flexible material to enable movement within a wide range of angles. For example, the curved piece 34 may consist of a flexible rubber material or may include a plurality of linked slats that are able to pivot with respect to each other.

When the printer 10 is resting on a flat surface, the movable cover 16 may be positioned in the closed position as shown in FIG. 1. The first slat 32 is pivotably attached to the first top portion 26 of the fixed structure 14, such as by one or more hinges. To open the cover 16, a user may handle the slats 32, 34, 36, 38, 40 to cause the first slat 32 to pivot with respect to the first top portion 26. More specifically, a pivoting mechanism may be formed between the first top portion 26 and the first slat 32 to enable the pivoting motion of the first slat 32 about an axis of the pivoting mechanism.

During an opening operation, the parallel linked slats 32, 34, 36, 38, 40 may also pivot with respect to one another to allow the movable cover 16 to be folded over the first top portion 26 and rest along the left-side portion 24 of the housing 12. It should be recognized that because of the multiple linked slats, the movable cover 16 can be opened such that a minimum amount of space around the housing 12 would be needed to move the movable cover 16 from a fully closed position to a fully opened position.

The front portion 18 of the printer 10 may include, for example, a print output device 42 and a user interface 44. The print output device 42 as shown in FIG. 1 may be configured for outputting a printed label. The user interface 44 may include input devices, such as buttons, switches, knobs, etc. The user interface 44 may also include output devices, such as display screens, indicator lights, audible output elements, etc.

In some embodiments, one or more of the slats 36, 38, 40 that make up the right-side portion 28 of the housing 12 may include a window 46. The window 46 allows the user to view the inside of the printer 10 without the need to remove the movable cover 16. The window 46 may be an opening or may include a transparent material, such as glass or clear plastic.

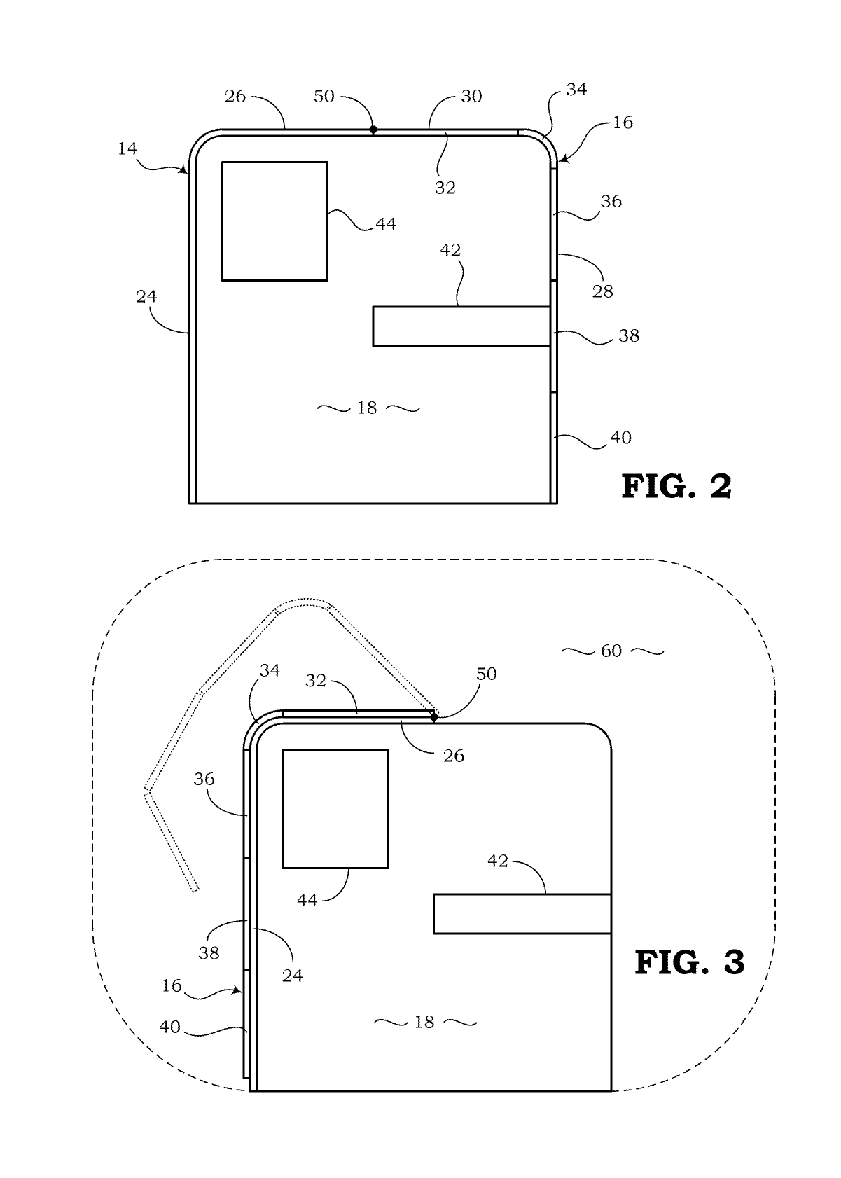

FIG. 2 is a front view of the printer of FIG. 1 in which the movable cover 16 is shown in the fully closed position. FIG. 3 is a front view of the printer of FIG. 1 with the movable cover 16 in a fully opened position. When opening, the movable cover 16 is pivoted about a first pivoting mechanism 50, such as a hinge, and the slats 32, 34, 36, 38, 40 can be placed over the top and left side of the fixed structure 14. For example, the first slat 32 is pivoted such that a surface of the first slat 32 may lay substantially flat against the first top portion 26 of the housing 12. When open, the second top portion 30 and the right-side portion 28 of the housing 12 are removed, thereby exposing the interior of the housing 12.

As shown in FIG. 3, a buffer space 60 is shown around the outside of the housing 12. The buffer space 60, outlined by dashed lines, defines the minimum amount of space that may be needed to enable the movable cover 16 to be folded over and extended over the first top portion 26 of the housing 12. Although the slats 32, 34, 36, 38, 40 may be extended parallel with each other to reach well beyond the buffer space 60, the forming of the movable cover 16 is multiple segments allows the slats to be pivoted with respect to each other such that they can be maintained within the buffer space 60, especially if the printer 10 is used in an environment with limited space. The buffer space 60 may be defined by the width of the slats.

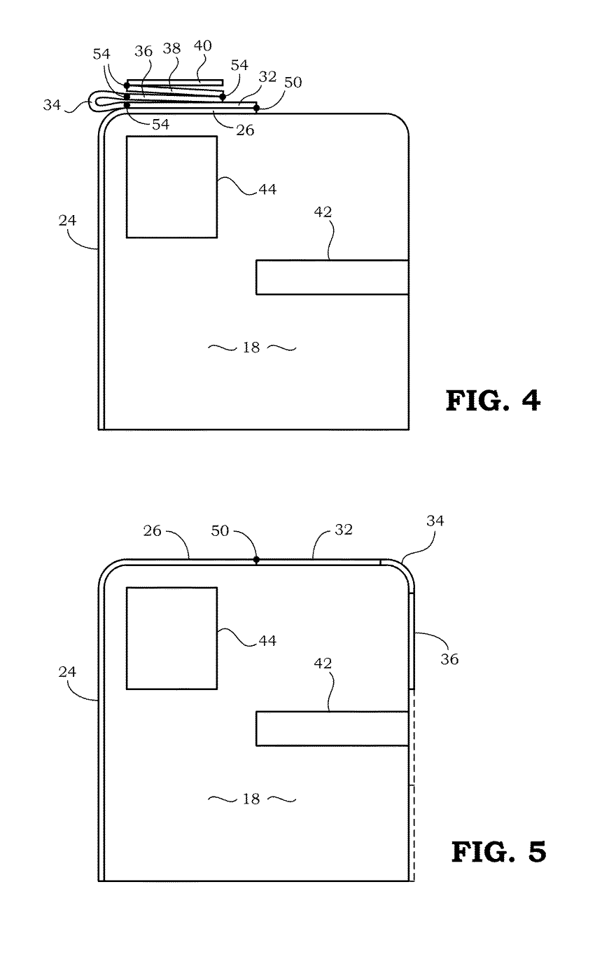

The movable cover 16 is constructed such that the first slat 32 is connected to the first top portion 26 of the fixed structure 14 via the first pivoting mechanism 50. The first pivoting mechanism 50 may include one or more hinges defining an axis and/or may be a flexible material that allows the first slat 32 to pivot with respect to the fixed structure 14. Also, second pivoting mechanisms 54, as shown in FIG. 4, are attached between each adjoining pairs of slats 32, 34, 36, 38, 40. Therefore, with the use of five slats as shown in the embodiment of FIG. 1, the movable cover 16 may have four of the second pivoting mechanisms 54, where each of the second pivoting mechanisms 54 may include one or more hinges and/or flexible material. Although the first pivoting mechanism 50 may only be designed to allow rotation of the first slat 32 over the top of the housing 12, the second pivoting mechanisms 54 may allow one slat to swing up to 360 degrees with respect to the adjoining slat.

The second pivoting mechanisms 54 interconnecting the slats 32, 34, 36, 38, 40 may be configured to allow the user to detach the slats from each other. The ability to detach the slats enables a user to customize the configuration of slats as needed to provide protection as well as to enable access to the internal components. For example, FIG. 5 illustrates an example of slats 38 and 40 being removed from the movable cover 16. In some embodiments, the slats may have a standard size and can then be used with printers having different sizes, which may simplify the manufacturing of the slats. For example, a shorter printer may have a height that requires two slats to cover the entire side, while a taller printer may have a height that requires four or more slats to cover its side.

Therefore, in light of the above disclosure, the printer 10 may be provided such that it comprises the housing 12 having the fixed structure 14 and the movable cover 16, wherein the movable cover 16 may be configured to be movable with respect to the fixed structure 14. The printer 10 may further comprise a printing mechanism (not shown) disposed inside the housing 12. The printing mechanism may be configured to print an image on a medium. The movable cover 16 is movably attached to the fixed structure 14 via a first pivoting mechanism 50 that defines a first pivoting axis. The movable cover 16 may be configured to be pivoted about the first pivoting axis of the first pivoting mechanism 50. The movable cover 16 comprises a plurality of linked slats 32, 34, 36, 38, 40, each pair of adjacent linked slats being linked together by a second pivoting mechanism 54. Each second pivoting mechanism 54 includes characteristics enabling a user to detach the adjacent linked slats 32, 34, 36, 38, 40 from each other (FIG. 5) if desired.

The fixed structure 14 comprises at least the bottom portion 22 of the housing 12, the front portion 18 of the housing 12, the back portion 20 of the housing 12, the left-side portion 24 of the housing 12, and the first top portion 26 of the housing 12. The movable cover 16 comprises at least the right-side portion 28 of the housing 12 and the second top portion 30 of the housing 12.

At least one linked slat (e.g., slat 32) of the plurality of linked slats 32, 34, 36, 38, 40 defines at least a part of the second top portion 30 of the housing 12 when the movable cover 16 is in a closed position. In an opened position, however, a surface of the at least one linked slat (e.g., slat 32) is positioned substantially flush with a surface of the first top portion 26 of the housing 12, as shown in FIGS. 3 and 4. In this way, when the movable cover 16 is moved to the opened position, it will be out of the way and will safely rest in a stable position without the risk of the cover accidentally closing on the user.

At least one other slat (e.g., slats 36, 38, 40) of the plurality of linked slats 32, 34, 36, 38, 40 defines at least a part of the right-side portion 28 of the housing 12 when the movable cover 16 is in the closed position. In the opened position, however, the at least one other slat (e.g., slats 36, 38, 40) includes a surface that is positioned substantially flush with a surface of the left-side portion 24 of the housing 12, as shown in FIG. 3. In some embodiments, one or more the slats 32, 34, 36, 38, 40 may include magnets connected to the edges thereof and likewise the edges of one or more of the front portion 18, back portion 20, and left-side portion 24 can include corresponding magnets. Therefore, the corresponding sets of magnets may help to hold the movable cover 16 in place whether it is in the closed position or in the opened position.

The movable cover 16 is configured to be pivoted between a fully closed position (FIG. 2) and a fully opened position (FIGS. 3 and 4). The fully opened position enables the user to access the printer mechanism. As shown in FIG. 3, the buffer space 60 around the outside of the housing 12 defines a minimum space that allows the movable cover 16 to be pivoted between the fully closed position and the fully opened position. For example, the buffer space 60 may be defined by the width of one of the linked slats 32, 34, 36, 38, 40. In the embodiment shown in FIGS. 1-5, for instance, the slat 30 has the greatest width of all the slats and therefore may be used to define the buffer space 60.

Each of the second pivoting mechanisms 54 shown in FIG. 4 includes a second pivoting axis that is substantially parallel with the first pivoting axis of the first pivoting mechanism 50. The substantially parallel axes allow the movable cover 16 to be opened and closed in a uniform manner. Each of the first and second pivoting mechanisms 50, 54 may include one or more hinges, or alternatively may include a flexible material, such as rubber or cloth.

The corner piece 34 of the movable cover 16 is configured to link at least one linked slat (e.g., slat 32) defining at least part of the second top portion 30 of the housing 12 with at least one linked slat (e.g., slat 36) defining at least part of the right-side portion 28 of the housing 12. The corner piece 34 defines an angle of approximately 90 degrees between the second top portion 30 of the housing 12 and the right-side portion 28 of the housing 12.

It should be noted that the corner piece 34 may also be bent at an angle of approximately 90 degrees in the other direction of rotation, thereby allowing the corner piece 34 to conform to the curvature of the top right corner of the housing 12 and to also conform to the curvature of the top left corner of the housing. The corner piece 34 will be bent by approximately 90 degrees in a first direction around the top right corner of the housing 12 when the movable cover 16 is in the closed position and will be bent by approximately 90 degrees in an opposite direction around the top left corner of the housing 12 when the movable cover 16 is in the opened position shown in FIG. 3. In other embodiments, the corner of the printer may be rectangular and regular hinges may be used to connect the corner slats in a pivoting arrangement.

According to some embodiments, the present invention may be implemented as a housing for any type of machine that provides a tangible output. The machine housing may include the fixed structure 14, the first pivoting mechanism 50 attached to the fixed structure 14, and the cover 16 attached to the first pivoting mechanism 50. The cover 16 may be configured to be pivoted with respect to the fixed structure 14 about the first pivoting axis of the first pivoting mechanism 50. When the cover 16 is in an opened position, a user may have access to the interior of the housing. The cover 16 comprises the plurality of linked slats 32, 34, 36, 38, 40, each pair of adjacent linked slats being linked together by the second pivoting mechanisms 54. Each second pivoting mechanism 54 includes characteristics enabling the user to detach the adjacent linked slats 32, 34, 36, 38, 40 from each other.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A printer, comprising:
a housing having a fixed structure and a movable cover, the movable cover configured to be movable with respect to the fixed structure; and
a printing mechanism disposed inside the housing, the printing mechanism configured to print an image on a medium;
wherein the movable cover is movably attached to the fixed structure via a first pivoting mechanism that defines a first pivoting axis, the movable cover configured to be pivoted about the first pivoting axis of the first pivoting mechanism; and
wherein the movable cover comprises a plurality of linked slats, each pair of adjacent linked slats being linked together by a second pivoting mechanism.

2. The printer of claim 1, wherein
the fixed structure comprises at least a bottom portion of the housing, a front portion of the housing, a back portion of the housing, a left-side portion of the housing, and a first top portion of the housing; and
wherein the movable cover comprises at least a right-side portion of the housing and a second top portion of the housing.

3. The printer of claim 2, wherein, in an opened position, at least one linked slat of the plurality of linked slats defining at least a part of the second top portion of the housing includes a surface that is positioned substantially flush with a surface of the first top portion of the housing.

4. The printer of claim 3, wherein, in the opened position, at least another of the plurality of linked slats defining at least a part of the right-side portion of the housing includes a surface that is positioned substantially flush with a surface of the left-side portion of the housing.

5. The printer of claim 1, wherein the cover is configured to stay in a fully opened position or fully closed position by means of magnets deployed on the plurality of linked slats, the front portion, the back portion and the left-side portion

6. The printer of claim 1, wherein:
a buffer space around the outside of the housing defines a minimum space that allows the movable cover to be pivoted between a fully closed position and the fully opened position; and
wherein the buffer space is defined by a width of one of the linked slats.

7. The printer of claim 1, wherein each of the first and second pivoting mechanisms includes one or more hinges and/or flexible material.

8. The printer of claim 1, wherein the movable cover further comprises a corner piece configured to link at least one linked slat defining the second top portion of the housing with at least one linked slat defining the right-side portion of the housing.

9. The printer of claim 8, wherein:
the corner piece is configured to bend by approximately 90 degrees in a first direction when the cover is in a closed position; and
the corner piece is configured to bend by approximately 90 degrees in an opposite direction to the first direction when the cover is in an open position.

10. The printer of claim 1, wherein one or more of the plurality of linked slats comprises a window.

11. A housing of a machine for providing a tangible output, the housing comprising:
a fixed structure;
a first pivoting mechanism attached to the fixed structure, the first pivoting mechanism defining a first pivoting axis; and
a cover attached to the first pivoting mechanism, the cover configured to be pivoted with respect to the fixed structure about the first pivoting axis;
wherein, when the cover is in an opened position, a user has access to the interior of the housing;
wherein the cover comprises a plurality of linked slats, each pair of adjacent linked slats being linked together by a second pivoting mechanism.

12. The housing of claim 11, wherein:
a buffer space around the outside of the housing defines a minimum space that allows the movable cover to be pivoted between a fully closed position and the fully opened position; and
wherein the buffer space is defined by a width of one of the linked slats.

13. The housing of claim 11, wherein the cover is configured to stay in a fully opened position or fully closed position by means of magnets deployed on the plurality of linked slats, the front portion, the back portion and the left-side portion.

14. The housing of claim 11, wherein each of the first and second pivoting mechanisms includes at least one hinge and/or a flexible material.

15. The housing of claim 11, wherein one or more of the plurality of linked slats comprises a window.

16. A method for allowing access to the interior of a machine, the method comprising:
rotating a cover attached to a fixed structure of the machine through a first pivoting mechanism about a first pivoting axis, wherein the cover comprises a plurality of linked slats, each pair of adjacent linked slats being linked together by a second pivoting mechanism; and
rotating the plurality of linked slats about a second pivoting axis such that the cover moves within a buffer space.

17. The method of claim 16, wherein the buffer space around the outside of the housing defines a minimum space that allows the cover to be pivoted between the fully closed position and the fully opened position; and wherein the buffer space is defined by a width of one of the linked slats.

18. The method of claim 16, wherein each of the first and second pivoting mechanisms includes at least one hinge and/or a flexible material.

19. The method of claim 16, comprising:
bending a corner piece by approximately 90 degrees in a first direction when the cover is in a closed position; and
bending the corner piece by approximately 60 degrees in an opposite direction to the first direction when the cover is in an open position.

20. The method of claim 16, wherein one or more of the plurality of linked slats comprises a window.
